(19) United States
(12) Patent Application Publication
(10) Pub. No.: US 2008/0024309 A1
(43) Pub. Date: Jan. 31, 2008

(54) RFID TAGS SUITABLE FOR AFFIXING TO RECTANGULAR CORNERS

(75) Inventors: Kristen Monroe Balhoff, Durham, NC (US); James Peter Branigan, Creedmoor, NC (US); Christian Lee Hunt, Cary, NC (US); Gregory Covert Smith, Raleigh, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/459,678

(22) Filed: Jul. 25, 2006

(51) Int. Cl. G08B 13/14

(52) U.S. Cl. 340/572.8; 340/572.7

(57) ABSTRACT

To make the antenna pattern of an RFID tag more nearly isotropic, the tag substrate is adapted to fit a corner of a rectangular structure. The substrate has tabs that may be folded, together with a remaining portion of the substrate so that the tag, may be installed on, for example, the corner of a box or crate. The antenna has at least two radiating elements. A first tab bears a portion of one radiating element, a second tab bears a portion of the other element, and a remaining portion of the substrate bears at least a portion of at least one of the radiating elements. When the tag is folded and affixed to a corner, parts of the antenna lie each of in the three mutually orthogonal planes that define the corner.

### FIELD OF THE INVENTION

The present invention concerns the field radio frequency identification (RFID), and more particularly concerns RFID tags adapted for affixing to corners of rectangular structures such as containers, packages, boxes, crates and the like.

### BACKGROUND

Generally, an RFID tag includes an RFID transceiver and a tag antenna. Passive RFID tags also include a power converter. The power converter converts electromagnetic energy received through the tag antenna when the tag is read by a tag reader into a form suitable to power the transceiver, in order that the transceiver may respond to the tag reader.

Ideally, the tag antenna would receive and radiate equally well in all directions. Such an antenna is known in theory as an isotropic radiator. In practice, however, antenna patterns are not isotropic, and in fact exhibit directional nulls. These nulls degrade the performance of an RFID system, in that the temporary orientation of a package bearing an RFID tag makes the RFID tag more or less visible to an RFID tag reader. For example, when an RFID tag reader surveys the contents of a cart full of small, randomly oriented packages with RFID tags, some of the tags may be read and others missed, based simply on the random orientations of the RFID tag antennas.

Thus, there is a need to provide RFID tags having antennas with patterns that more nearly approach that of the ideal isotropic radiator, so that RFID tags bearing these antennas can be read more reliably.

### SUMMARY

Aspects of the invention include an RFID tag suitable for affixing to a corner of a rectangular structure such as a container, package, box, crate, and the like. The tag includes an RFID transceiver and a single antenna that has at least a first radiating element and a second radiating element on a substrate. The substrate is adapted to proved tabs that may folded, together with a remaining portion of the substrate, to conform to a corner of the rectangular structure. One tab bears a portion of the first radiating element, another tab bears a portion of the second radiating element, and the remaining portion of the substrate bears at least a portion of at least one of the radiating elements. Thus, when the tag is folded and affixed to a corner of a rectangular structure, parts of the antenna lie in each of the three mutually orthogonal planes that form the corner, thereby improving the radiating pattern of the antenna.

### BRIEF DESCRIPTION OF THE SEVERAL VIEWS OF THE DRAWINGS

The invention may be better understood by reading the following detailed description together with the drawings, wherein:

FIG. 1 shows a block diagram of a conventional RFID tag, according to the prior art;

FIG. 2 shows an RFID tag having an antenna comprising a pair of perpendicular dipoles;

FIGS. 3A-3B show how the substrate of an RFID tag may include a notch to provide tabs that may be folded so that the tag conforms to a corner of a rectangular structure;

FIGS. 4A-4B show how the substrate of an RFID tag may include two notches to provide tabs that may be folded so that the tag conforms to a corner of a rectangular structure;

FIGS. 5A-5B show how the substrate of an RFID tag may include three notches to provide tabs that may be folded so that the tag conforms to a corner of a rectangular structure,

FIGS. 6A-6B shows how the substrate of an RFID tag may include a cut to provide tabs that may be folded so that the tag conforms to a corner of a rectangular structure; and

FIGS. 7A-7B show how the substrate of an RFID tag having a serpentine antenna may include tabs that may be folded so that the tag conforms to a corner of a rectangular structure.

### DETAILED DESCRIPTION

The present invention will now be described more fully hereinafter, with reference to the accompanying drawings, in which illustrative embodiments of the invention are shown. The drawings are not necessarily to scale. Throughout the drawings, like numbers refer to like elements.

The invention may, however, be embodied in many different forms, and should not be construed as limited to the embodiments set forth herein; rather, these embodiments are provided so that the disclosure will be thorough and complete, and will fully convey the scope of the invention to those skilled in the art.

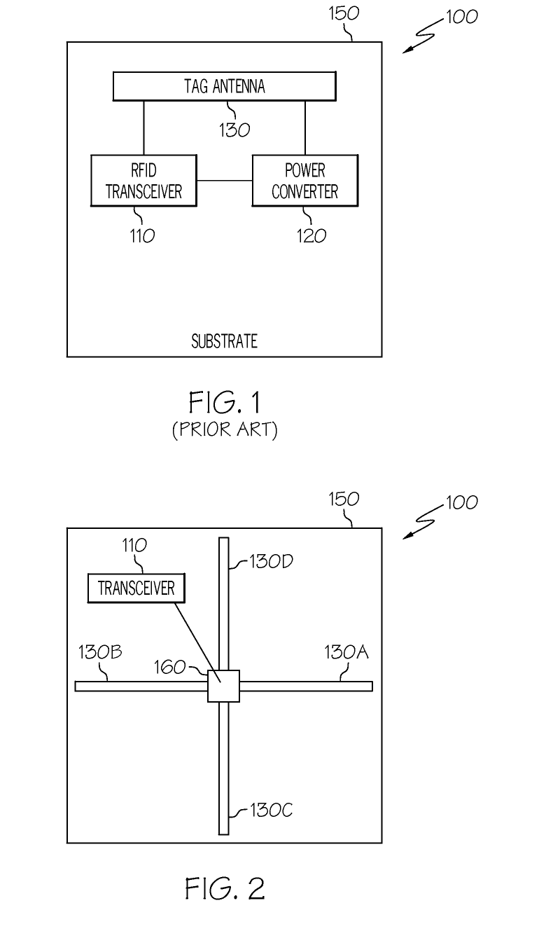

FIG. 1 shows a block diagram of an RFID tag 100. The diagram is introduced as a descriptive convenience rather than a limitation of the invention. As shown in FIG. 1, the RFID tag 100 comprises a substrate 150, an RFID transceiver 110, and a tag antenna 130.

As is well known to those skilled in the art, a passive RFID tag receives electromagnetic energy through the tag antenna 130 when read or queried by a tag reader. In a passive tag, a power converter 120, which may be, for example, a rectifier and a simple filter such as a capacitor, transforms the received energy into a form suitable to power the transceiver 110, in order that the transceiver 110 may respond to the tag reader. In contrast to passive RFID tags, active RFID tags may include an internal power source such as a small battery, which eliminates the need to power the transceiver 110 from energy received by the tag antenna 130. The invention applies to both passive and active RFID tags. As a descriptive convenience, the power converter 120 is not shown explicitly in the other figures.

In preferred embodiments of the invention, the RFID antenna 130 comprises at least two radiating elements which, when portions thereof are folded as described below, have dissimilar radiation patterns. The radiating elements, which may be loops or may be open ended, may be made of conducting foil or film, or conducting ink, or the like. Here, the radiating elements constitute a single antenna fed from a single feed point, as contrasted with a plurality of independent antennas, one of which is selected by a switch of some kind. The feed point for the antenna may be provided by a combiner or impedance matching device 160. For example, the tag antenna 130 may comprise a pair of dipoles 130A-130B and 130C-130D of conducting foil combined at the feed point 160 and arranged on the substrate 150 to be mutually perpendicular, as shown in FIG. 2, although the invention is not limited to dipoles.

The RFID 110 and the tag antenna 130 are carried by a substrate 150 made from flat stock. In preferred embodiments of the invention, the substrate 150 may be a thin, flexible substance such as, for example, polypropylene or polyolefin with the approximate thickness of bond paper. Contact adhesive may be applied to one side of the substrate 150 so that the RFID tag 100 may be conveniently affixed to an item that is to be tracked. For descriptive convenience, the drawings show the substrate 150 as rectangular. This is not, however, a condition of the invention.

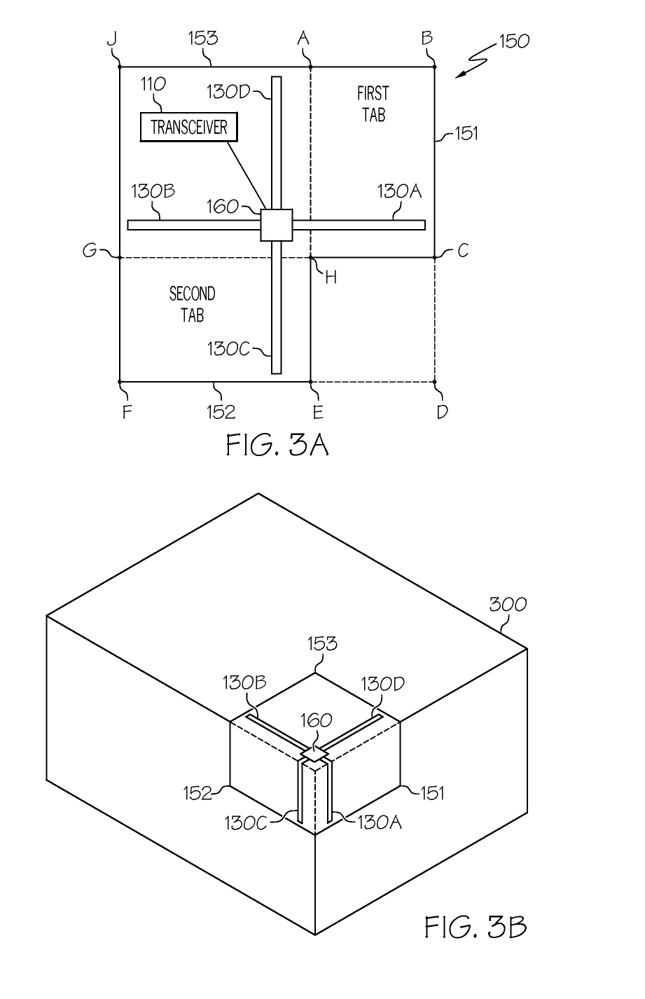

Figures 3A-7B show examples of how the substrate 150 may be adapted to proved tabs that may be folded so that the tag fits or conforms to a corner of a rectangular structure. To simplify the drawings, the transceiver 110 is not always shown separately. In the associated description and appended claims, the term “portion of a radiating element” means part or all of the radiating element.

In the embodiment illustrated by FIG. 3A, two tabs 151, 152 result from a notch in the substrate 150. The first tab 151 is shown as the region of the substrate 150 defined by the points labeled (A, B, C, H); the second tab 152 is shown as the region defined by the points labeled (E, F, G, H); the remaining portion 153 of the substrate is defined by the points labeled (A, H, G, J); and the notch is indicated as a region bounded by the points labeled (C, D, E, H), which has been removed from the substrate. The first tab 151 bears a portion of the radiating element 130A; the second tab 152 bears a portion of the radiating element 130C; and the remaining portion 153 of the substrate bears at least one portion of at least one of the radiating elements, in this example the entire radiating elements 130B and 103D.

FIG. 3B shows such a tag folded to fit a corner of an examplary rectangular structure 300. When the tag is so folded and affixed to such a corner, parts of the antenna lie in each of the three mutually orthogonal planes that form the corner, thereby improving the radiating pattern of the antenna.

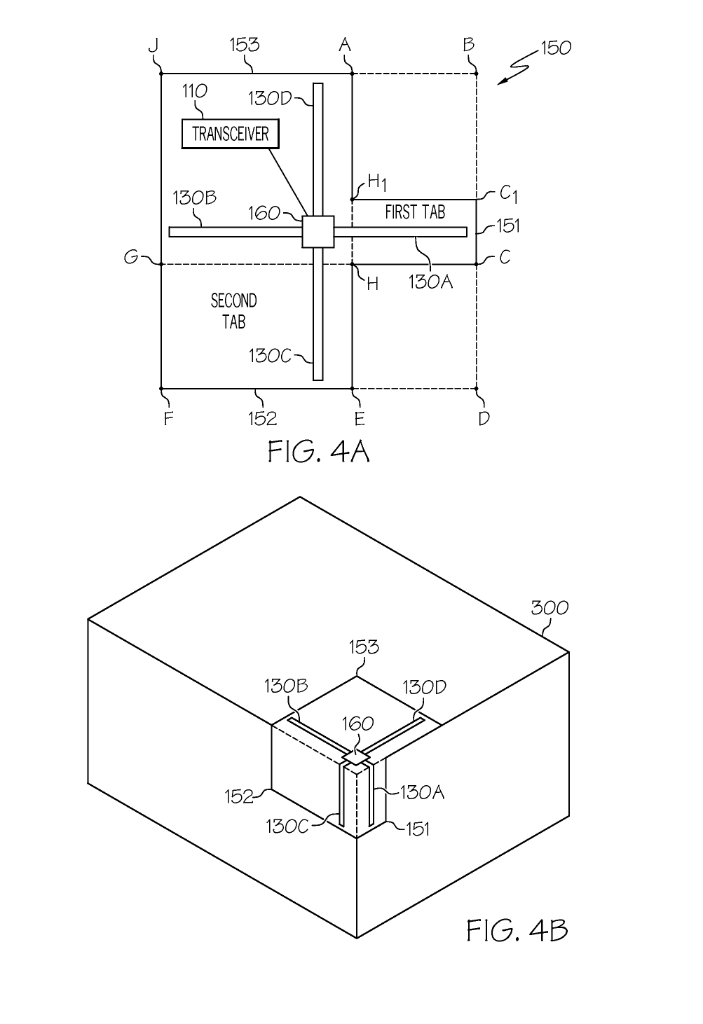

In the embodiment illustrated by FIG. 4A, the tabs 151, 152 result from two notches in the substrate 150. The first tab 151 is shown as the region of the substrate 150 defined by the points labeled (C′, C, H, H′); the second tab 152 is shown as the region defined by the points labeled (E, F, G, H); and a remaining portion 153 of the substrate is defined by the points labeled (A, H′, H, G, J). One of the notches is shown as a region bounded by the points labeled (C, D, E, H), and the other notch is shown as a region bounded by the points labeled (A, B, C′, H′). The first tab 151 bears a portion of the radiating element 130A; the second tab 152 bears a portion of the radiating element 130C; and the remaining portion of the substrate 153 bears at least one portion of at least one of the radiating elements, in this example the entire radiating elements 130B and 130D. FIG. 4B shows such a tag folded to fit a corner of the exemplary rectangular structure 300.

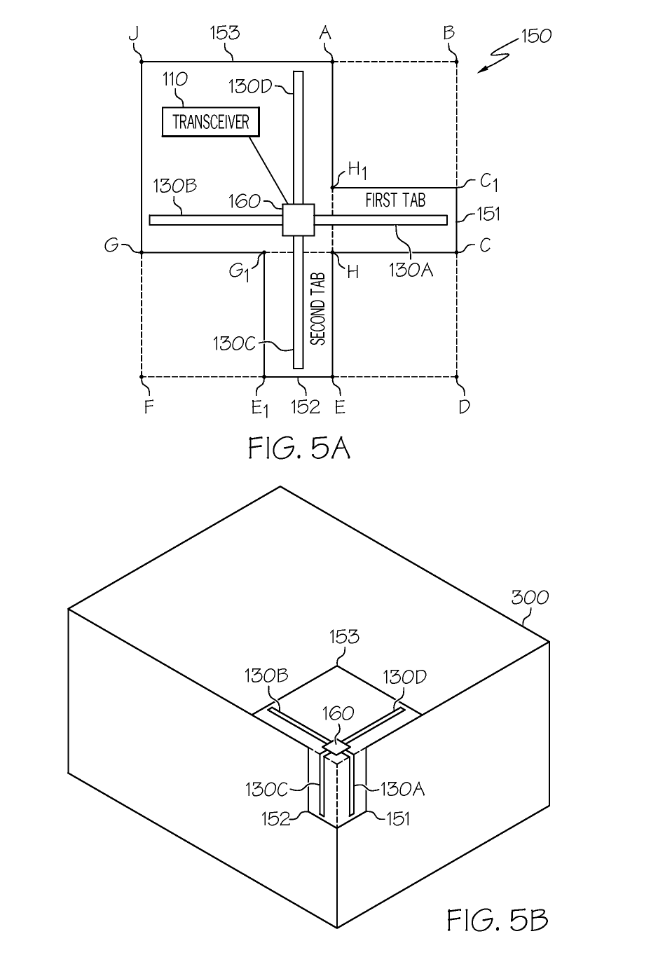

In the embodiment illustrated by FIG. 5A, the tabs 151, 152 result from three notches in the substrate 150. The first tab 151 is shown as the region of the sustrate 150 defined by the points labeled (C′, C, H, H′); the second tab 152 is shown as the region defined by the points labeled (E, E′, G′, H); and a remaining portion 153 of the substrate is defined by the points labeled (A, H′, H, G′, G, J). One notch is shown as a region bounded by the points labeled (C, D, E, H); another notch is shown as a region bounded by the points labeled (A, B, C′, H′); and a third notch is shown as a region bounded by the points labeled (G, G′, E′, F). The first tab 151 bears a portion of the radiating element 130A; the second tab 152 bears a portion of the radiating element 130C; and the remaining portion 153 of the substrate bears at least one portion of at least one of the radiating elements, in this example the entire radiating elements 130B and 130D. Figure 5B shows such a tag folded to fit a corner of the exemplary rectangular structure 300.

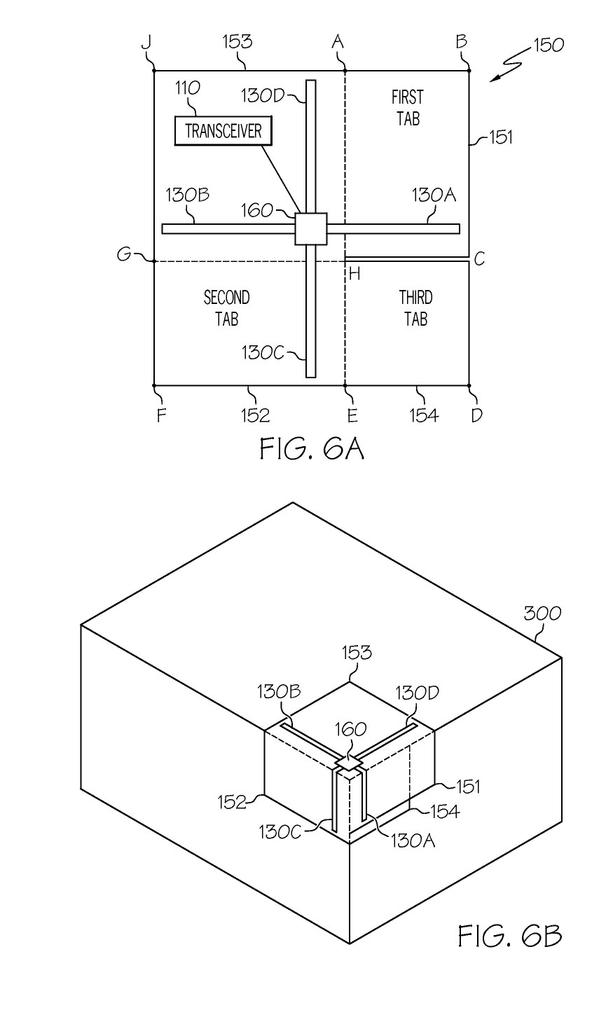

The tabs may also result from one or more cuts in the substrate. In the exemplary embodiment illustrated by FIG. 6A, tabs 151, 152, and 154 are provided by a single cut from point C to point H in the substrate 150. In the figure, the width of the cut is exaggerated for clarity. In practice, none of the substrate necessarily needs to be removed; the substrate may simply be cut. The first tab 151 is shown as the region of the substrate 150 defined by the points labeled (A, B, C, H); the second tab 152 is shown as the region defined by the points labeled (E, F, G, H); and the third tab 154 is shown as the region of the substrate defined by the points labeled (A, H, G, J). The first 151 bears a portion of the radiating element 130A; the second tab 152 bears a portion of the radiating element 130C; and the remaining portion of the substrate 153 bears at least one portion of at least one of the radiating elements, in this example the entire radiating elements 130B and 130D. FIG. 6B shows such a tag folded to fit a corner of the exemplary rectangular structure 300. When installing the RFID tag, tab 154 may be affixed to the structure before tab 151, thereby placing tab 154 underneath tab 151.

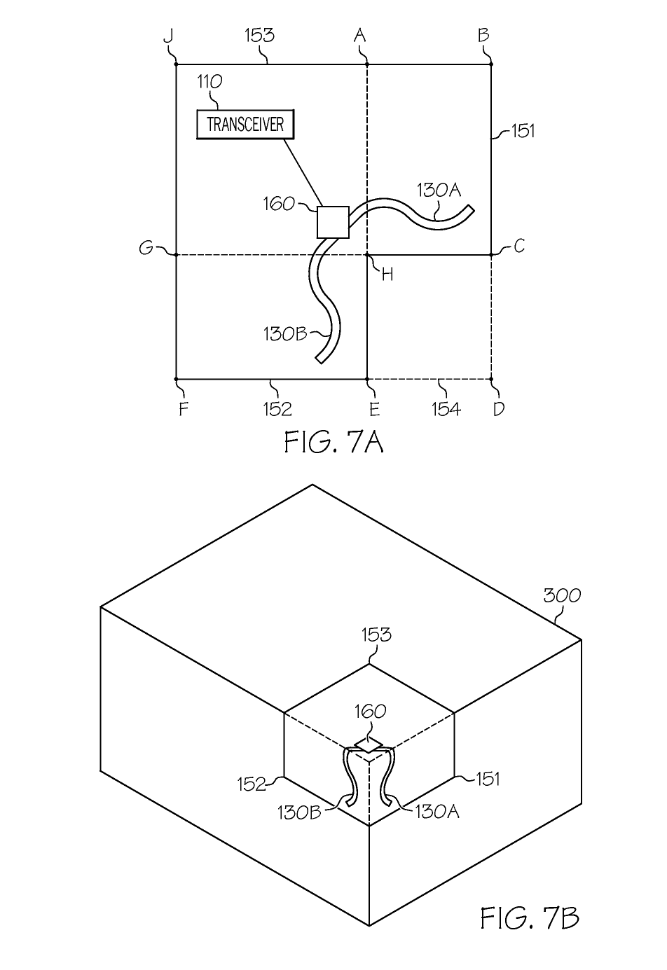

All of the substrate adaptations described above apply as well when the tag antenna 130 is serpentine. For example, in the embodiment illustrated by FIG. 7A, the tag antenna 130 has two serpentine radiating elements 130A and 130B. In the case of a one-notch adaptation of the substrate 150, which is the case shown in Fig 7A, two tabs 151, 152 again result from a notch in the substrate. The first tab 151 is shown as the region of the substrate 150 defined by the points labeled (A, B, C, H); the second tab 152 is shown as the region defined by the points labeled (E, F, G, H); a remaining portion 153 of the substrate is defined by the points labeled (A, H, G, J); and the notch is indicated as a region bounded by the points labeled (C, D, E, H). The first tab 151 bears a portion of the radiating element 130A; the second tab 152 bears a portion of the radiating element 130B; and the remaining portion 153 of the substrate bears a portion of each of the radiating elements 130A and 130B. FIG. 7B shows such a tag folded to fit a corner of the exemplary rectangular structure 300.

Although the foregoing has described various embodiments of RFID tags that are suitable for affixing to corners of rectangular structures, the description of the invention is illustrative rather than limiting. Once taught the invention, those skilled in the art will understand that the invention encompasses numerous other arrangements of cuts, notches, and the like to provide foldable tabs. Thus, the invention is limited only by the claims that follow.

We claim:

1. An RFID tag with a substrate adapted for affixing to a corner of a rectangular structure, said tag comprising: an RFID transceiver operably connected to a single antenna comprising a first radiating element and a second radiating element; wherein the substrate has a first tab and a second tab that may be folded, together with a remaining portion of the substrate, to fit a corner of a rectangular structure, the first tab bearing a portion of the first radiating element, the second tab bearing a portion of the second radiating element, and the remaining portion of the substrate bearing at least a portion of at least one of the radiating elements.

2. The RFID tag of claim 1, wherein the tabs result from at least one notch in the substrate.

3. The RFID tag of claim 1, wherein the tabs result from one notch in the substrate.

4. The RFID tag of claim 1, wherein the tabs result from two notches in the substrate.

5. The RFID tag of claim 1, wherein the tabs result from three notches in the substrate.

6. The RFID tag of claim 1, wherein the tabs result from at least on cut in the substrate.

7. An RFID tag with a substrate adapted for affixing to a corner of a rectangular structure, said tag comprising: an RFID transceiver operably connected to a single antenna comprising a first dipole and a second dipole perpendicular to the first dipole; wherein the substrate has a first tab and a second tab that may be folded, together with a remaining portion of the substrate, to fit a corner of a rectangular structure, the first tab bearing a portion of the first dipole, the second tab bearing a portion of the second dipole, and the remaining portion of the substrate bearing at least a portion of at least one of the dipoles.

8. The RFID tag of claim 7, wherein the tabs result from at least one notch in the substrate.

9. The RFID tag of claim 7, wherein the tabs result from one notch in the substrate.

10. The RFID tag of claim 7, wherein the tabs result from two notches in the substrate.

11. The RFID tag of claim 7, wherein the tabs result from three notches in the substrate.

12. The RFID tag of claim 7, wherein the tabs result from at least on cut in the substrate.

13. The RFID tag of claim 7, wherein the tabs result from a cut that extends inward from an edge of the substrate toward the first dipole, paralleling the second dipole.
